(19) United States
(12) Patent Application Publication
(10) Pub. No.: US 2008/0281929 A1
(43) Pub. Date: Nov. 13, 2008

(54) System and Method of Automatic Multi-Media Mail

(76) Inventor: Weng-Jeng Peng, Taipei (TW)

Correspondence Address: TUNG & ASSOCIATES / RANDY W. TUNG, ESQ., 838 W. LONG LAKE RD., SUITE 120, BLOOMFIELD HILLS, MI, 48302, US

(21) Appl. No.: 11/836,252

(22) Filed: Aug. 9, 2007

(30) Foreign Application Priority Data
May 11, 2007 (TW) 096116793

(51) Int. Cl. G06F 15/16

(52) U.S. Cl. 709/206

(57) ABSTRACT

The present invention provides an automatic multi-media mail system which is (1) installed in a website that provides the Internet mail service, or (2) working in conjunction with an Internet mail server used by a user. In the first case, the present invention provides multi-media information recording functions through the Internet. In the latter case, the present invention separates multi-media information from a text mail and stores the multi-media information so that a user can transmit and/or access the multi-media information bypassing the Internet mail server.

### FIELD OF INVENTION

The present invention relates to a system and method of automatic multi-media mail, in which a sender can directly record a multi-media file, and send it through an Internet mail; a receiver can directly view or listen to the multi-media file without opening an attached file; and the mail will not be rejected by a mail server due to its capacity limitation.

### BACKGROUND OF THE INVENTION

In the context of the present invention, “multi-media” includes video information alone, audio information alone, and video and audio information in combination.

Today, it has become more popular to send multi-media files through Internet mails. However, the conventional carrier (mail server and related Internet services, etc.) designed for transmitting pure text mails can not catch up with this trend.

Presently, the most common method to send a multi-media file is to put it in the form of an attached file (in a format such as wmv, avi, mpeg, etc.) to a text mail. This method creates a lot of inconveniences such as: (1) there must be an equipment and related software for recording audio and video information and the sender must be familiar with the process of operating such equipment and related software; (2) the size of the attached multi-media file may be too large that the mail cannot be sent out, or that the mail will be blocked by the server on the receiver side; and (3) even if the receiver successfully receives the multi-media file, he/she would need to have corresponding software to open the file. In short, such method of sending a multi-media file faces limitations on mail server capacities and software support. Such method is also not friendly to a user unfamiliar with computer.

In addition to the Internet e-mails, there are other carriers capable of providing instant audio/video communication between parties, such as ICQ, AIM, Yahoo Messenger, MSN Messenger, and etc. However, such instant communication can only be achieved when both parties are on line concurrently. If either one of the parties is off line, the carrier can only transmit text information, but not multi-media information.

Taiwan patent application No. 90102312 discloses a method for sending a multi-media file via an Internet mail. Specifically, when the mail is opened by the receiver, the multi-media file automatically displays its content without the need to open the attachment. However, this prior art does not solve the above-mentioned problem where the recording operation is not friendly to the sender. In addition, with respect to the mail size problem, this cited prior art reduces the size of the attached multi-media file by file compression technique. This does not actually solve the capacity problem because the size of the mail may still be too large and cause the mail server to reject file even after it has been compressed.

U.S. Pat. Nos. 6,223,213, 6,460,075, and 6,963,903 disclose methods for viewing and sending a multi-media mail under browser environment. Although these three patents improve the conventional recording process, the operation steps are still complicated and not user friendly. A user has to go through multiple window interfaces and steps to record a multi-media file in his/her local terminal, and upload the multi-media mail to a server by clicking a send button. Moreover, the cited prior arts not only do not solve the mail size problem, they also do not propose a solution for user who is not using a browser mail system.

In summary, none of the prior art references solve all three problems: (1) recording operation being cumbersome for the sender; (2) that mail servers, on either the sender or the receiver end, reject the over sized mail; (3) the requirement of a corresponding software program to open the multi-media file.

### SUMMARY OF THE INVENTION

In view of the foregoing drawbacks, the present invention proposes a system and a method of automatic multi-media mail where a user needs not worry about the size of an attached file or whether the format of the recorded multi-media information can be supported by a receiver's computer. The system and the method are very user friendly; the transmission and display of the multi-media file is also straight forward. In addition, the present invention is applicable to both the browser mail system and the personal computer mail system.

One objective of the present invention is to provide a system of automatic multi-media mail to solve the problems described previously. The system can be installed (1) in a website providing the Internet mail service, or (2) in conjunction with an Internet mail server used by a user. In the first case, the present invention provides the multi-media information recording functions through the Internet. In the latter case, the present invention separates multi-media information from a text mail and stores the multi-media information so that a user can bypass the Internet mail server to transmit and/or access the multi-media information.

It is another objective of the present invention to provide a method of automatic multi-media mail.

In one aspect of the present invention, an automatic multi-media mail system for transmitting a multi-media mail between a sender side and a receiver side is provided. The sender side is equipped with a multi-media recording equipment and the system comprises: an input/output interface for communicating with external environment; a mail server coupled to the input/output interface for handling transmission and receipt of a mail; and a multi-media server coupled to the input/output interface for handling storage and display of multi-media information, wherein the system is coupled to the multi-media recording equipment at the sender side via the Internet to record a sender's multi-media information into a multi-media file and store it in the multi-media server.

According to another aspect of the present invention, the automatic multi-media mail system with a sender mail server comprises: an input/output interface for communicating with external environment; a system mail server coupled to the input/output interface for handling transmission and receipt of a mail; and a multi-media server coupled to the input/output interface for handling storage and display of multi-media information, wherein the multi-media mail includes a text mail and an attached multi-media file; the system receives the multi-media file and stores it in the multi-media server.

According to another aspect of the present invention, an automatic multi-media mail method for transmitting a multi-media mail where the sender side is equipped with multi-media recording equipment is proposed. The method comprises: linking to the multi-media recording equipments at the sender side via the Internet to record a sender's multi-media information into a multi-media file; generating a text mail including a token for triggering a link to the multi-media file; and sending the text mail to the receiver side.

The present invention proposes another automatic multi-media mail method for transmitting a multi-media mail between a sender side and a receiver side. The sender side uses a sender mail server to send mails. The method comprises: receiving a text mail and an attached multi-media file generated by a sender; detaching the multi-media file from the text mail, and transmitting the multi-media file to a multi-media server bypassing the sender mail server; adding a token in the text mail for triggering a link to the multi-media file; and sending the text mail to the receiver side by the sender mail server.

Preferably, an integrated user interface is provided to the sender side for text input and multi-media information recordation. Also preferably, when a receiver opens a mail, the multi-media information is automatically displayed in the same window that the receiver views the content of a mail or a list of mails.

More preferably, the foregoing is executed according to a distributed system.

It is to be understood that both the foregoing general description and the following detailed description are provided as examples only, and should not be considered to limit the scope of the present invention.

### BRIEF DESCRIPTION OF THE DRAWINGS

These and other features, aspects, and advantages of the present invention will become better understood with regard to the following description, appended claims, and accompanying drawings where:

FIG. 1 shows a first system embodiment according to the present invention;

FIGS. 2A and 2B are flow charts explaining how a sender records and uploads a multi-media file;

FIG. 3 shows an example of a user interface;

FIG. 4 explains how to display an input area;

FIG. 5 explains how a receiver reads a multi-media file;

FIG. 6 shows a second system embodiment according to the present invention;

FIG. 7 is a flow chart explaining how a sender records and uploads a multi-media file in the second system embodiment; and

FIG. 8 is a flow chart explaining how a receiver reads a multi-media file in the second system embodiment.

### DETAILED DESCRIPTION OF THE PREFERRED EMBODIMENT

In the first embodiment of the present embodiment, the establishment, storage and display of a multi-media file are all achieved by a website. (As used in the context of the present invention, a “website” does not only mean a web page, but also refers to hardware such as a server and back-up storage, or software such as programs and interfaces).

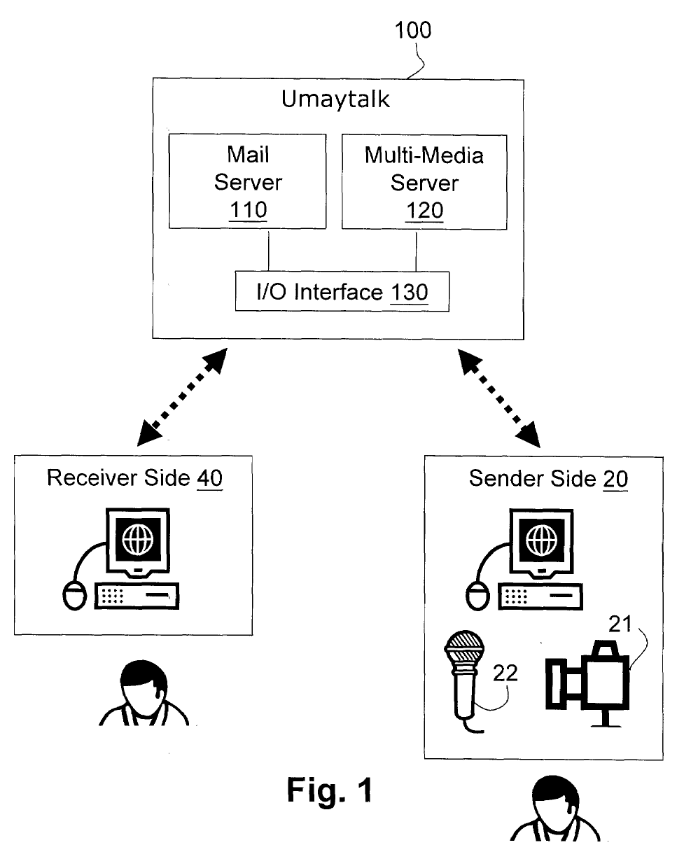

Referring to FIG. 1, a website Umaytalk 100 communicates with a sender side 20 and a receiver side 40. The Umaytalk website 100 includes a mail server 110, a multi-media server 120 and an input/output interface (I/O interface) 130. The Umaytalk website 100 communicates with external environment through its I/O interface 130. If there is a text mail to send/receive, the send/receive action of the mail is processed by the mail server 110. If there is a multi-media mail to send/receive, the storage and display of the multi-media is processed by the multi-media server 120. A sender records a multi-media file and stores it in the multi-media server 120. The Umaytalk website 100 sends a mail to the receiver side 40 via the mail server 110 and the mail includes an automatic link to the multi-media file. When a receiver opens the mail to read its content, the link is automatically triggered to display the multi-media file from the multi-media server 120 to the receiver side 40. In programming technique, the automatic link is preferably achieved by means of a token, instead of a hyperlink which requires a user to trigger it manually.

In the context of the present invention, the term “send” or “transmit” is used in a broad sense that includes the transmission of a “file”, a “content”, or a “message”, while the file does not necessarily have to be transferred from one place to another. As described in more detail hereinafter, if the receiver also uses the Umaytalk website 100 as his/her mail system, the mail file is stored in the mail server 110. It is only when the receiver accesses the mail and reads it that the system downloads or streams the content of the mail to the receiver side 40. Similarly, the term “download” as used in the context of the present invention includes “transmission of a file” or “display of the content by streaming”, but the file does not necessarily have to be first stored in a local terminal and then executed. It should be further noted that the description and figures are provided for better illustration of the spirit of the present invention, but not for limiting the scope of the invention. The I/O interface 130 can be integrated with any of the servers. The mail server 110 and the multi-media server 120 do not necessarily have to be two separate hardware equipments. One who is skilled in the art can readily think of possible alternatives to provide multiple server functions through one server equipment, such as by parallel processing technique. The details of such technique and other alternatives are not described here for that they are irrelevant to the key spirit of the present invention.

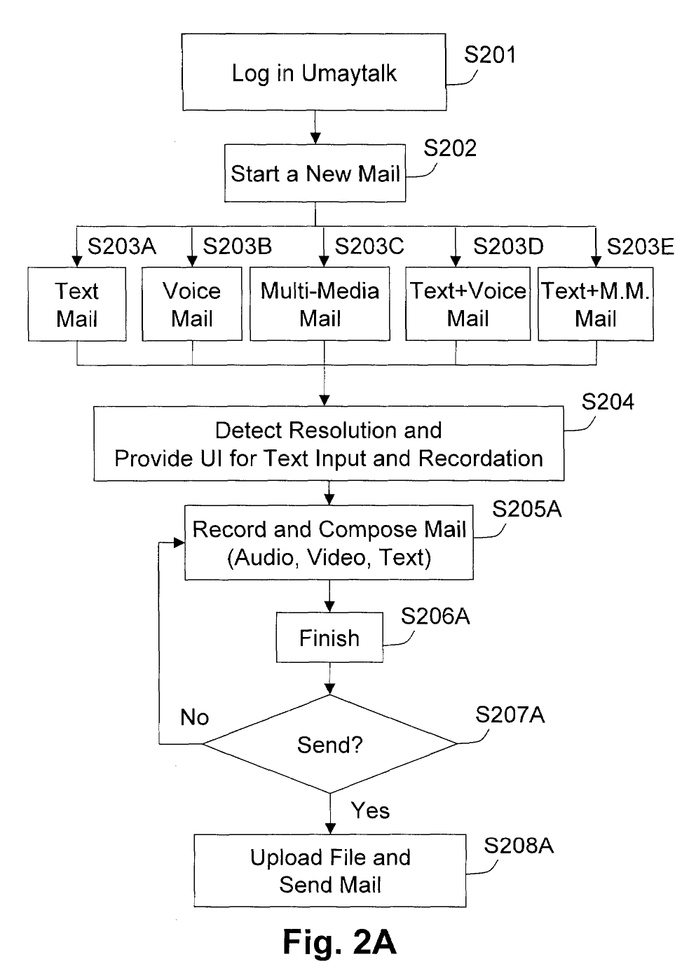

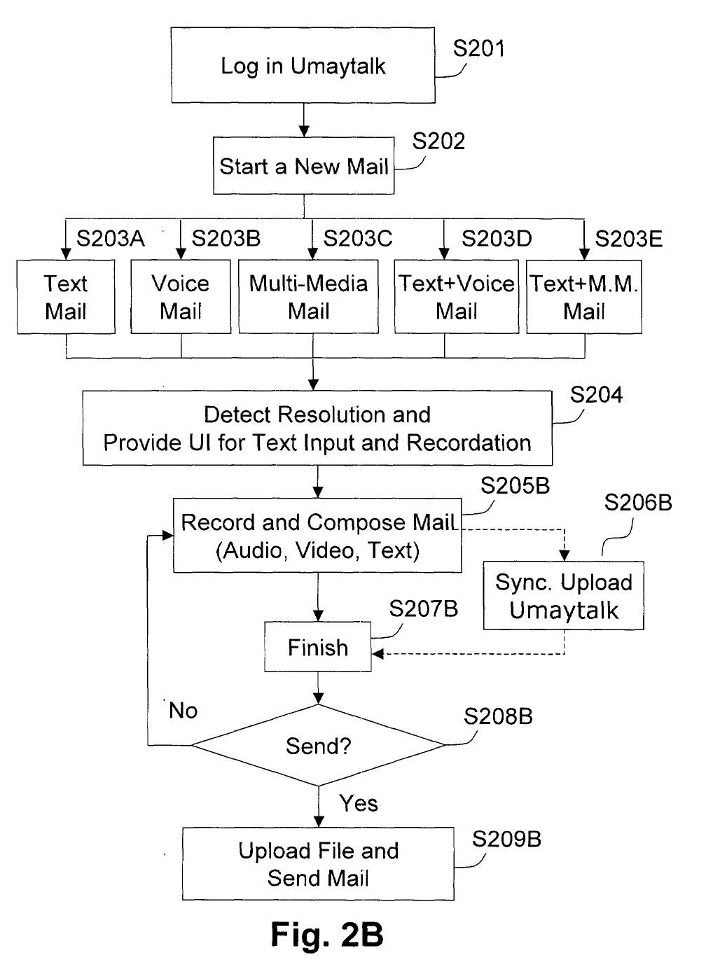

Please refer to the flowcharts of FIGS. 2A and 2B, with reference to FIGS. 1 and 3.

When a sender logs in the Umaytalk website 100 (Step S201), the website 100 sends a user interface “starting a new mail” to the sender side 20 (Step S202). In one embodiment, the Umaytalk website 100 provides multiple options to the sender; he/she can choose to write a text mail, to record a voice mail, to record a multi-media mail (M.M. mail), or to create a text mail with voice (text+voice mail), or to create a text mail with multi-media information (text+M.M. mail), as shown by steps S203A-S203E. These options are given by, e.g., providing icons or a pull-down menu or both, on the user interface. After the sender makes his/her decision, in step S204 the Umaytalk website 100 detects the resolution of the computer screen at the sender side (details to be explained later), and displays a recording area and a text input area concurrently. An example of the user interface to be displayed is shown in FIG. 3, which includes a text input area 31 that can be scrolled up and down for unlimited text length, and a recording area 32 along with several function buttons. Of course, other interface arrangements are also possible, but the key feature here is “not to open another window, but to provide an integrated user interface”, so that a user needs not switch between multiple windows. FIG. 3 is shown as an example when the sender chooses to create a text mail with multi-media information. The same applies if a simple voice mail or a multi-media mail is selected, except that the text input area 31 is not displayed. If what is chosen is a text mail, the recording area 32 is not required.

Next, through interaction between the Umaytalk website 100 and the sender side 20, the sender side 20 records a multi-media file by means of recording equipments such as a web-cam 21 and/or a microphone 22. The sender then sends the file to the Umaytalk website 100 via the Internet to store it in the multi-media server 120 of the website 100 (steps S205A-208A of FIG. 2A, or steps S205B-209B of FIG. 2B). The multi-media file may be stored in electronic or other (such as optical) formats.

More specifically, please refer to FIG. 2A, starting from the step S205A. In the embodiment of FIG. 2A, a sender first records a multi-media file (with text, if required), and after confirmation (steps 206A-207A), uploads the file to the Umaytalk website 100 (step 208A). Thereafter, the Umaytalk website 100 sends a mail to notify the receiver side 40. The recording and uploading of the multi-media file can be achieved by several ways. In one embodiment, the sender side 20 is equipped with the multi-media recording equipments, and the Umaytalk website 100 is capable of recognizing the format of the electronic multi-media file recorded by the sender by means of such recording equipments. The driver program for driving the recording equipments can be permanently installed in the sender side 20, or stored in the Umaytalk website 100 and only temporarily downloaded to the memory of the sender side 20 when required. In another embodiment, the sender side 20 uses its own program to record multi-media information into an electronic file and then uploads the file. The multi-media server 120 of the Umaytalk website 100 is equipped with various popular multi-media software programs (i.e., multi-media file execution programs), and it can automatically identify the format of the electronic file sent by the sender.

FIG. 2B shows another embodiment, in which the steps S201-S204 are the same as those in FIG. 2A. Starting from step S205B, the sender records and uploads multi-media information synchronously to the Umaytalk website 100 (steps S205B-207B), creating a multi-media file in the Umaytalk website 100. After confirmation (step S208B), the Umaytalk website 100 sends a mail to notify the receiver side 40 (step S209B). In this embodiment, the network connection between the sender side 20 and the Umaytalk website 100 is sufficiently fast; the recording equipments at the sender side 20 simply receive and transmit the multi-media information, while the consolidation of such information into a multi-media file is done in the multi-media server 120 of the Umaytalk website 100. Note that the term “synchronously” in the above context does not have to mean strictly “at the same time”; the term is used to distinguish the present embodiment from the previous embodiment wherein uploading is performed only after the whole recording operation is completed at the sender side 20. If the recorded multi-media information is sent periodically by packets, it is not uploaded “at the same time” as it is recorded, but it falls in the spirit of “synchronously” in the present embodiment.

In either the flow of FIG. 2A or 2B, the present invention is characterized in that a user only needs to operate a very simple user interface to record multi-media information. In addition, FIG. 2B describes a function to synchronously upload information, which saves time because the sender can immediately send a mail after finishing recording without waiting for the recorded file to be uploaded.

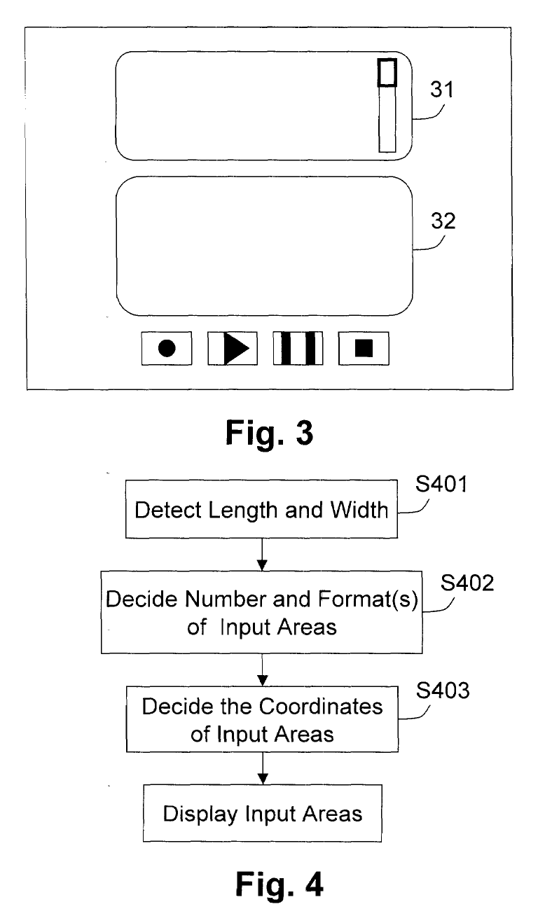

The process flow for displaying a screen for text input and/or recording in the step S204 in FIG. 2B is further explained below. Referring to FIG. 4, in step S401, the system detects the length and width of the user's screen, which is, e.g., 1024*768 pixels. And, according to the mail format chosen by the user, the number and format(s) of the input areas are decided; that is, the system decides to display either the text input area alone, or the recording area alone, or both (step S402). Further, based on the length and width of the user's screen, the coordinates of the input areas (the text input area 31 and/or the recording area 32) are decided, and the areas are shown on the screen (step S403). The sequence of the steps S401-S403 is not strictly limited to the above; the steps are interchangeable.

If necessary, the Umaytalk website 100 can categorize the mail from a sender and tag it as a text mail, a voice mail, a multi-media mail, a text+voice mail, or a text+M.M. mail, to facilitate better management functions such as file compression, notification to a receiver, etc.

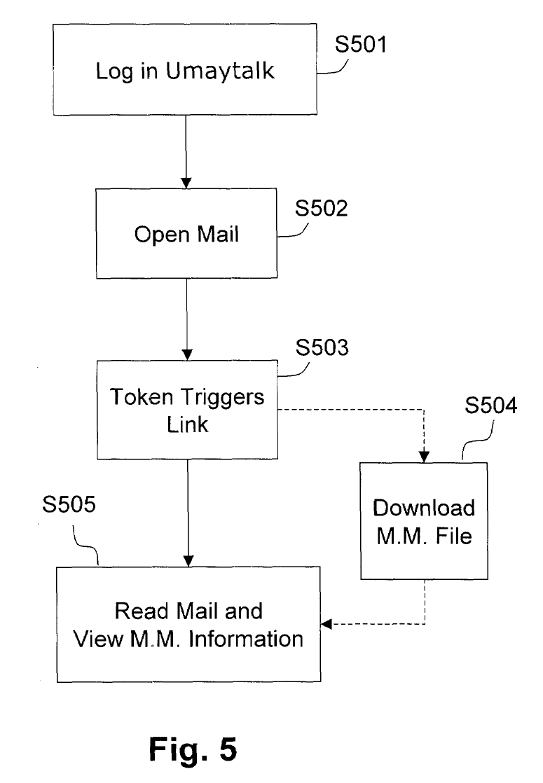

After the completion of the multi-media information recording, a text mail, containing an automatic link to the recorded multi-media file, is sent to the receiver. The “text mail” here can be a blank mail; that is, it can be one that does not contain any text content, not even a subject title. Referring to FIG. 5, if the receiver is also a user of the Umaytalk website 100, then the text mail is stored in the mail server 110, and the receiver has to log onto the Umaytalk website 100 to read the mail (step S501). When the receiver opens the mail (step S502), the token in the mail triggers the link (step S503) and the system automatically displays the multi-media information from the multi-media server 120 to the receiver side 40 (step S504). The system also downloads a corresponding program for displaying the multi-media information to the receiver side 40, if required.

Depending on the preference of the receiver, the system can be arranged so that the multi-media information is not automatically displayed when the receiver opens the mail, but is expressed in some other forms. For example, it can be arranged so that when the receiver stops a cursor on the subject title or the date of a multi-media mail, the system provides a thumbnail screenshot of the multi-media information. Only after the receiver clicks the mail will the system display the whole multi-media information. There are many other alternatives to achieve the same purpose under the spirit of the present invention. In short, a friendly arrangement is preferred, so that the receiver can conveniently read/view a multi-media mail by a very simple action (or by no action), in the same window for viewing the mail (the text of a mail or the list).

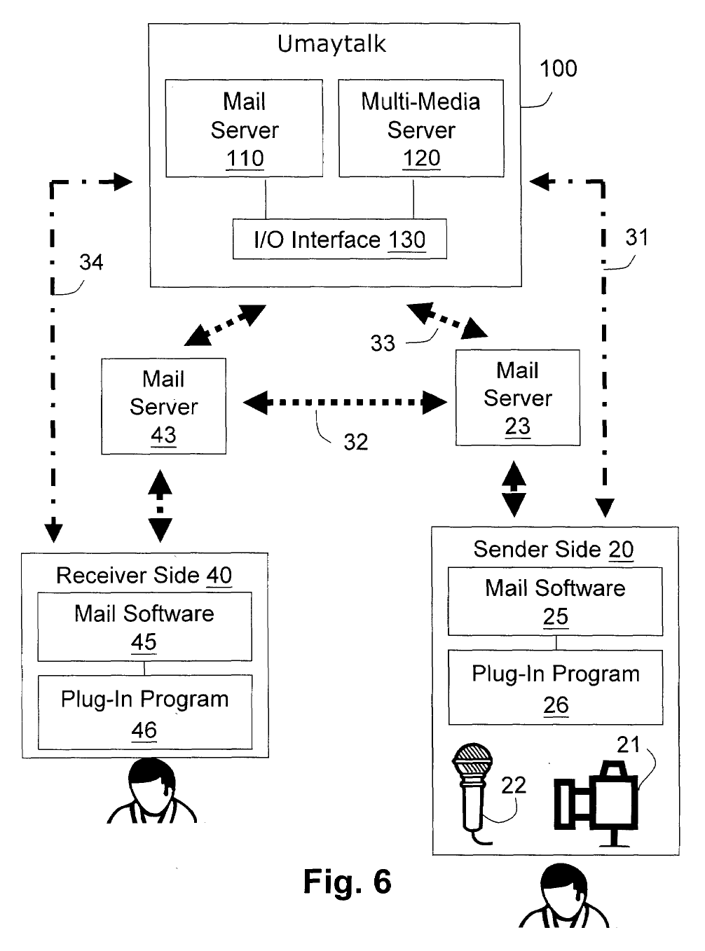

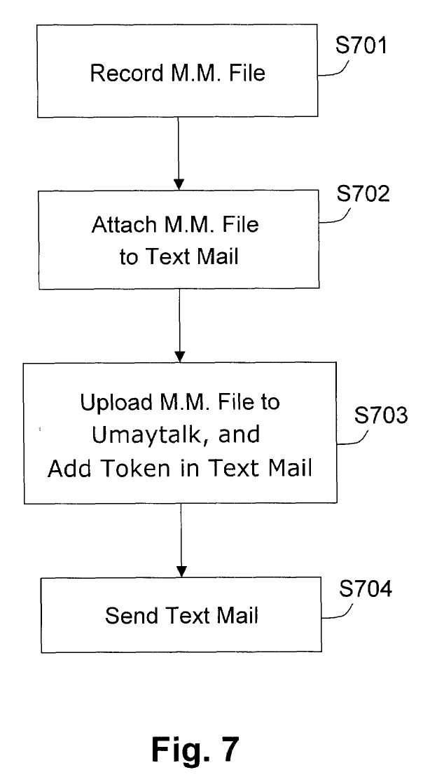

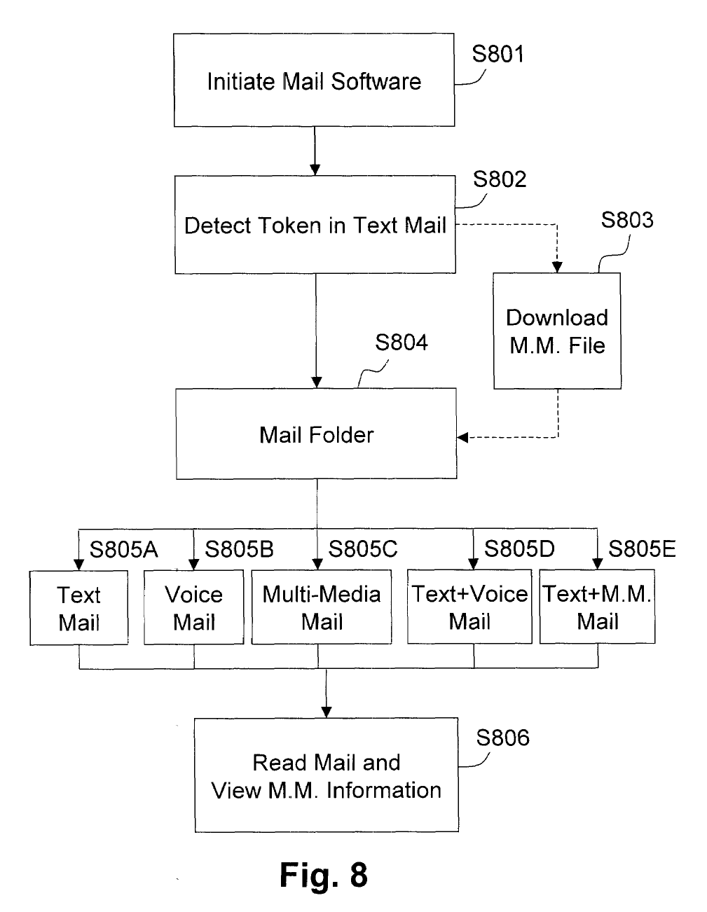

In the first system and the corresponding method embodiments, both the sender and the receiver use the Umaytalk website 100 as their mail system. Referring to FIG. 6, in the second system and the corresponding method embodiments, the sender and the receiver do not both have to use the Umaytalk website 100 as their mail system; either the sender side 20 or the receiver side 40, or both, can use mail software 25, 45 (such as Outlook, Outlook Express, etc.) in conjunction with mail servers 23, 43 to send/receive mails. (Or, they can use the mail software 25, 45 in conjunction with the mail server 110; in this case the mail servers 23, 43 are not required). In the second system and the corresponding method embodiments, a plug-in program 26 is provided in the mail software 25, and a plug-in program 46 is provided in the mail software 45. The process to send and to receive a mail is described below with reference to FIGS. 7 and 8.

If the sender sends mails through his/her mail software 25 (if the sender uses the Umaytalk website 100 as his/her mail system, then it is similar to the case shown in the right hand part of FIG. 1), the sender records a multi-media file according to normal practice (step S701), and mails it as an attachment to a text mail (step S702). As described in the foregoing, the text mail can be a blank mail without any text content, even without a subject title. At the time when the mail is sent, the plug-in program 26 automatically logs in the Umaytalk website 100 and uploads the attached multi-media file to the multi-media server 120 of the Umaytalk website 100, and adds a token in the text mail (step S703). Please note that the multi-media file is uploaded, not sent through the mail, as shown by the path 31 in FIG. 6; that is, although the text mail is sent via the mail server 23 (path 32 of FIG. 6), the multi-media file has been transferred into a certain form of linkage (not limited to a hyperlink). From the viewpoint of the Umaytalk website 100, the process is similar to that shown in FIG. 2A, except that the mail is not sent by the Umaytalk website 100. From the viewpoint of the mail server 23, it only sends the text mail without the attached multi-media file; thus, it will not reject the mail because of its size.

The plug-in program 26 can be downloaded from the Umaytalk website 100 by the user, or can be automatically downloaded and installed by other means. To be user-friendly, in addition to transferring the attached multi-media file, the plug-in program 26 can further add functional buttons on the user interface provided by the mail software 25. For example, when a functional button is pressed, the plug-in program 26 generates a user interface similar to that of FIG. 3, so that the sender can send a text+M.M. mail by the manner described in the first embodiment (without using an attachment), but still in the software environment that the sender is accustomed to.

If the receiver uses the Umaytalk website 100 as his/her mail system, the text mail will be sent to the mail server 110 of the Umaytalk website 100 (the path 33 of FIG. 6); the manner that the receiver reads the text mail and views the multi-media file is the same as that in FIGS. 1 and 5.

Referring to FIG. 8, if the receiver receives mails through his/her mail software 45 and mail server 43, since the attached multi-media file is not directly mailed to the mail server 43, the mail will not be rejected by the mail server 43 due to oversize. When the receiver uses the mail software 45 to receive mails (step S801), the plug-in program 46 detects the token in lieu of the multi-media file included in the mail (step S802), and logs in the Umaytalk website 100 to download the multi-media file stored in the multi-media server 120 according to the link implied by the token. A corresponding display software program is downloaded along with the multi-media file, if required (step S803, and the path 34 of FIG. 6). After downloading, the mail is put into an inbox folder (step S804) and being categorized (steps S805A-805E). Depending on the preference of the receiver, the multi-media file can be expressed as an attachment, or automatically displayed when the receiver opens the mail, as described above, etc. (step S806).

As seen from the above, the present invention is more user friendly than any prior art. A sender can send a multi-media mail very conveniently; a receiver can view the multi-media information without pre-installing particular software. Moreover, neither the sender nor the receiver has to be concerned about the file size limitation or other restrictions that may cause mail transmission failure. According to the present invention, a user does not have to change his/her behavior, nor does he/she have to purchase costly hardware, in order to upgrade the traditional text mail transmission to a more advanced multi-media mail transmission. The present invention thus provides great advantages.

In addition to the above, because there may be many people concurrently viewing the same multi-media file (for example, the same mail is sent to many receivers), it is preferred that the multi-media file is read in accordance with a distributed system and method for better efficiency. In a distributed system, every downloader is also an uploader. After a downloader receives a part of information, for that part of information, in the subsequent process, it becomes an uploader who concurrently uploads that part of information and downloads other parts of information. In other words, the information transmission is processed among multiple points. The more the downloaders are, the larger the total uploading bandwidth, and thus the faster the transmission. The details of a distributed system are omitted here because they are known by one skilled in this art.

Although the present invention has been described in considerable detail with reference to certain preferred embodiments, these embodiments are for illustrative purpose and not for limiting the scope of the present invention. Other variations and modifications are possible. For example, the Umaytalk website 100 does not have to be a website open to public access; it can be a local terminal in a local area network (LAN). As another example, the relationships among the servers in the shown embodiments are only illustrative, not limiting; other alternatives are possible, and as an example, the servers 23 and 43 may communicate through an intermediate website, or certain hardware, rather than directly communicate with each other as shown in FIG. 6. As a further example, the transmission of the multi-media file does not have to be accompanied by a text mail. In view of the foregoing, it is intended that the present invention covers all such modifications and variations, which should be interpreted to fall within the scope of the following claims and their equivalents.

What is claimed is:

1. An automatic multi-media mail system for transmitting a multi-media mail between a sender side and a receiver side, the sender side being equipped with a multi-media recording equipment, the system comprising:
an input/output interface for communicating with external environment;
a mail server coupled to the input/output interface for handling transmission and receipt of a mail; and
a multi-media server coupled to the input/output interface for handling storage and display of multi-media information, wherein the system links to the multi-media recording equipments at the sender side via the Internet to record a sender's multi-media information into a multi-media file and store it in the multi-media server.

2. The automatic multi-media mail system of claim 1, wherein the multi-media information is recorded into a multi-media file at the sender side, and stored into the multi-media server.

3. The automatic multi-media mail system of claim 1, wherein the multi-media information is synchronously stored into the multi-media server when it is recorded.

4. The automatic multi-media mail system of claim 1, wherein the system sends a text mail to the receiver side, and the text mail includes a token in lieu of the multi-media information.

5. The automatic multi-media mail system of claim 4, wherein the token automatically triggers a link to display the multi-media information when the receiver side opens the text mail.

6. The automatic multi-media mail system of claim 1, wherein the system provides an integrated user interface to the sender side for text input and multi-media information recordation.

7. An automatic multi-media mail system for transmitting a multi-media mail between a sender side and a receiver side, the sender side using a sender mail server to send mails, the system comprising:
an input/output interface for communicating with external environment;
a system mail server coupled to the input/output interface for handling transmission and receipt of a mail; and
a multi-media server coupled to the input/output interface for handling storage and display of multi-media information, wherein the multi-media mail includes a text mail and an attached multi-media file; the system receives the multi-media file and stores it in the multi-media server.

8. The automatic multi-media mail system of claim 7, wherein the sender side is provided with a sender side plug-in program which uploads the multi-media file to the multi-media server in the system, and adds a token in the text mail which has been detached from its attached multi-media file.

9. The automatic multi-media mail system of claim 8, wherein the text mail which has been detached from its attached multi-media file is sent through the sender mail server.

10. The automatic multi-media mail system of claim 8, wherein the receiver side is provided with a receiver side plug-in program which detects the token in the text mail and downloads the multi-media information from the multi-media server to the receiver side.

11. The automatic multi-media mail system of claim 10, wherein the receiver side uses a receiver mail server to receive mails, and the text mail which has been detached from its attached multi-media file is received through the receiver mail server.

12. The automatic multi-media mail system of claim 7, wherein the sender side or the receiver side uses mail software to send or receive mails.

13. The automatic multi-media mail system of claim 8, wherein the sender side plug-in program provides an integrated user interface to the sender side for text input and multi-media information recordation.

14. A method for transmitting a multi-media mail between a sender side and a receiver side, the sender side being equipped with multi-media recording equipment, the method comprising:
linking to multi-media recording equipment at the sender side via the Internet to record a sender's multi-media information into a multi-media file;
generating a text mail that includes a token for triggering a link to the multi-media file; and
sending the text mail to the receiver side.

15. The automatic multi-media mail method of claim 14, further comprising: providing an integrated user interface to the sender side for text input and multi-media information recordation.

16. The automatic multi-media mail method of claim 15, wherein the step of providing an integrated user interface includes:
detecting the length and width of a sender's screen;
deciding the number and formats of input areas to be displayed; and
deciding the coordinates of the input areas according to the length and width of the screen, and displaying the input areas.

17. The automatic multi-media mail method of claim 14, further comprising: displaying the multi-media information according to the link triggered by the token when the receiver side opens the text mail.

18. The automatic multi-media mail method of claim 17, further comprising:
providing a plurality of multi-media file execution programs;
identifying the format of the multi-media file; and
executing the multi-media file by using one of the plurality of execution programs that corresponds to the format of the multi-media file.

19. The automatic multi-media mail method of claim 14, further comprising: providing a driver program for driving the multi-media recording equipment, wherein the driver program can be downloaded to the sender side.

20. The automatic multi-media mail method of claim 14, wherein the multi-media information is displayed according to a distributed system.

21. An automatic multi-media mail method for transmitting a multi-media mail between a sender side and a receiver side, the sender side using a sender mail server to send mails, the method comprising:
receiving a text mail and an attached multi-media file sent by a sender;
detaching the multi-media file from the text mail, and transmitting the multi-media file to a multi-media server bypassing the sender mail server;
adding a token in the text mail for triggering a link to the multi-media file; and
sending the text mail to the receiver side by the sender mail server.

22. The automatic multi-media mail method of claim 21, wherein the receiver side uses a receiver mail server to receive mails, and the method further comprising: receiving the text mail through the receiver mail server; triggering the link to the multi-media file by the token; and downloading the multi-media file from the multi-media server bypassing the receiver mail server.

23. The automatic multi-media mail method of claim 21, further comprising: providing a sender plug-in program to the sender side, wherein the sender plug-in program provides an integrated user interface for text input and multi-media information recordation.

24. The automatic multi-media mail method of claim 21, further comprising: providing a sender plug-in program to the sender side, the sender plug-in program detaching the multi-media file from the text mail.

25. The automatic multi-media mail method of claim 22, further comprising: providing a receiver plug-in program to the receiver side wherein the receiver plug-in program downloads the multi-media file from the multi-media server, and displaying the multi-media file in the same window where a receiver views the content of a mail or a list of mails.

26. The automatic multi-media mail method of claim 22, wherein the multi-media file is downloaded according to a distributed system.
